(19) United States
(12) Patent Application Publication
(10) Pub. No.: US 2009/0213486 A1
(43) Pub. Date: Aug. 27, 2009

(54) DATA RECORDING DEVICE

(75) Inventor: Tsuyoshi Takahashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/368,616

(22) Filed: Feb. 10, 2009

(30) Foreign Application Priority Data
Feb. 21, 2008 (JP) 2008-040023

(51) Int. Cl. G11B 21/02

(52) U.S. Cl. 360/75

(57) ABSTRACT

A data recording device for storing data, the data recording device includes: a medium for storing data; a head assembly including a read element for reading out data stored in the medium and a heater for controlling a distance between the read element and the medium within a predetermined range during data reading out by the read element; and a processor for executing a test process comprising: controlling the distance between the read element and the medium in a test range outside the predetermined range by controlling the heater, and reading out test data from the medium while the distance between the read element and the medium is maintained in the test range so as to evaluate the data recording device.

### CROSS-REFERENCE TO RELATED APPLICATIONS

This application is based upon and claims the benefit of priority of the prior Japanese Patent Application No. 2008-040023, filed on Feb. 21, 2008, the entire contents of which are incorporated herein by reference.

### FIELD

The embodiments relate to a data recording device.

### BACKGROUND

Magnetic recording devices using magnetic recording media are widely used in magnetic disk devices such as a hard disk drive (HDD). A flying height of a head above a disk medium becomes smaller and smaller in the magnetic recording device as a recording density of the magnetic recording medium increases. Every attempt has been made to improve a head flying face of the head and a disk medium surface of the recording disk in order to prevent a head crash caused by a head-disk interference. The head-disk interference (HDI) is typically caused by variations in the flying height.

Read performance and write performance of the magnetic head, and reliability related to HDI are greatly affected by variations in the flying height. Recently methods of controlling the flying height with the magnetic disk device itself have been proposed as disclosed in Japanese Laid-open Patent Publication No. 2005-71546 and Japanese Laid-open Patent Publication No. 2007-310978.

Spacing margin with respect to a defect on a disk medium is lowered in flying height control, and a need for improvements in the defect detection method of the medium is mounting.

Methods of detecting in advance a projection, as a potential defect, of a magnetic disk likely to cause a thermal asperity phenomenon later on have been proposed. In a first method as disclosed in Japanese Laid-open Patent Publication No. 10-172101, a rotation speed of the magnetic disk is reduced below a standard speed, a projection of the medium is detected from the output of a magnetic head, and the detected located of the projection is registered as a defect location.

In a second method as disclosed in Japanese Laid-open Patent Publication No. 2002-288822, a magnetic disk is rotated with a magnetic disk device housed in a constant-temperature bath set to be higher in temperature than normal operating temperature. A projection of a medium is detected from an output of a magnetic head, and the detected location is then registered as a defect location.

In accordance with these disclosed medium defect detection methods, the flying height of the magnetic head is reduced and a projection of the medium is detected by lowering the rotational speed of the magnetic disk or by placing the device in the constant-temperature bath. A medium projection, which cannot be detected in a medium defect detection at a standard flying height, can be detected beforehand.

The above-described first and second methods are intended only to detect a projection that is highly likely to cause the thermal asperity phenomenon, and have difficulty in detecting a defect location due surface roughness of the magnetic layer of the magnetic disk.

In the first method, the magnetic disk is driven at a speed lower than in normal operation, and data transfer rate and bit per inch (BPI) are different from those in the normal operation. The detection of a defect location becomes difficult due to read errors or the like. In the second method, the defect detection is performed in a high temperature atmosphere. The read output becomes different from that in the normal operation. The detection of a defect location becomes difficult due to read errors or the like.

In the related art, the defect detection is performed with the flying height reduced. It is thus difficult to detect a defect (read error) due to irregularity in the thickness of a magnetic file when the flying height increases.

### SUMMARY

According to an aspect of the invention, a data recording device for storing data includes: a medium for storing data; a head assembly including a read element for reading out data stored in the medium and a heater for controlling a distance between the read element and the medium within a predetermined range during data reading out by the read element; and a processor for executing a test process includes: controlling the distance between the read element and the medium in a test range outside the predetermined range by controlling the heater, and reading out test data from the medium while the distance between the read element and the medium is maintained in the test range so as to evaluate the data recording device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a magnetic recording device in accordance with one embodiment of the present invention.

FIG. 2 illustrates a magnetic head of FIG. 1.

FIG. 3 illustrates a pushing operation of the magnetic head by a heater in FIG. 2.

FIG. 4 illustrates a relationship between a heater current and a heater power of the heater illustrated in FIGS. 2 and 3.

FIG. 5 illustrates a relationship between the heater power illustrated in FIGS. 2 and 3 and a push amount of the magnetic head.

FIG. 6 is a characteristic chart of a flying height of the magnetic head in FIG. 1 changing radially across and with respect to a magnetic disk.

FIG. 7 illustrates a relationship the flying height of the magnetic head of FIG. 1 and a signal-to-noise ratio (SNR) of a read signal.

FIG. 8 illustrates a relationship between the SNR of FIG. 7 and an error rate.

FIG. 9 illustrates the flying height of a slider including the magnetic head of FIG. 1 with respect to the magnetic recording medium.

FIG. 10 illustrates a thermal asperity detection operation that explains a head flying height control in accordance with one embodiment of the present invention.

FIG. 11 is a flowchart illustrating a heater power map production process for the head flying height control in accordance with one embodiment of the present invention.

FIG. 12 illustrates a heater power map produced in the process of FIG. 11.

FIG. 13 illustrates another heater power map produced in the process of FIG. 11.

FIG. 14 illustrates variations in the heat flying height in a medium defect detection process in accordance with one embodiment of the present invention.

FIG. 15A, FIG. 15B, and FIG. 15C illustrate a potential medium defect in accordance with one embodiment of the present invention.

FIG. 16A, FIG. 16B, FIG. 16C, and FIG. 16D illustrate a medium defect detection method in accordance with one embodiment of the present invention.

FIG. 17A and FIG. 17B are flowcharts of the medium defect detection process in accordance with one embodiment of the present invention.

FIG. 18 is a flowchart illustrating a read and write process in accordance with one embodiment of the present invention.

### DESCRIPTION OF EMBODIMENTS

Embodiments of the present invention will be explained with reference to accompanying drawings.

Magnetic Recording Device

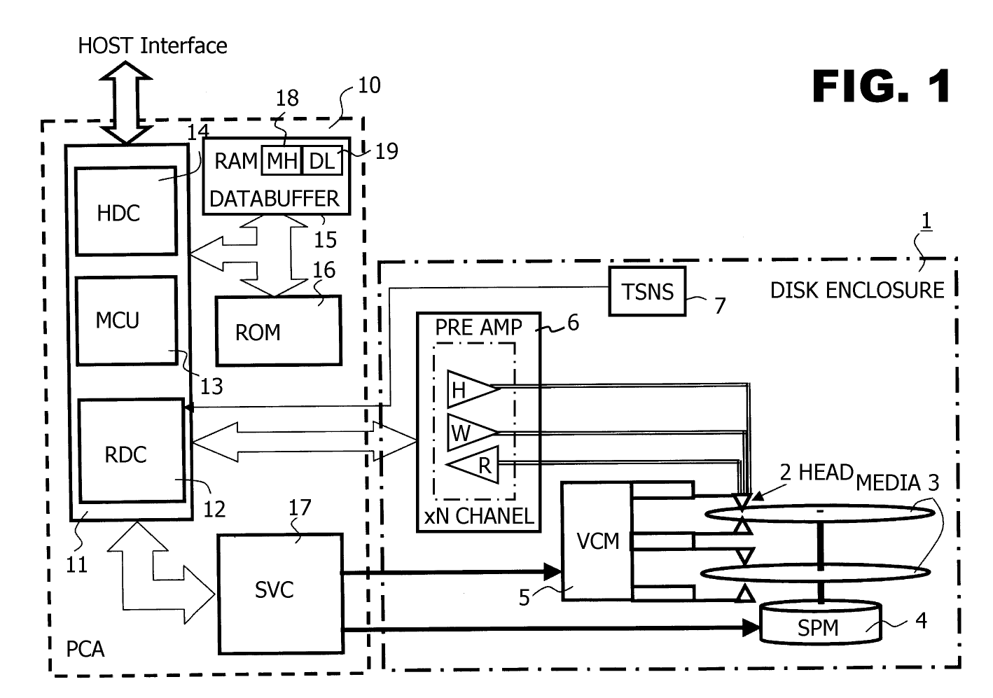

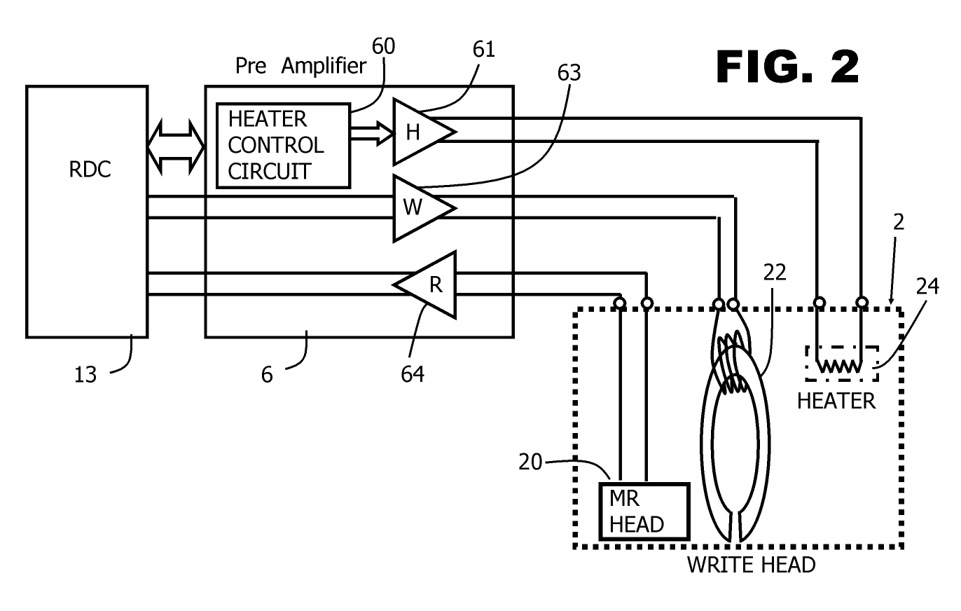

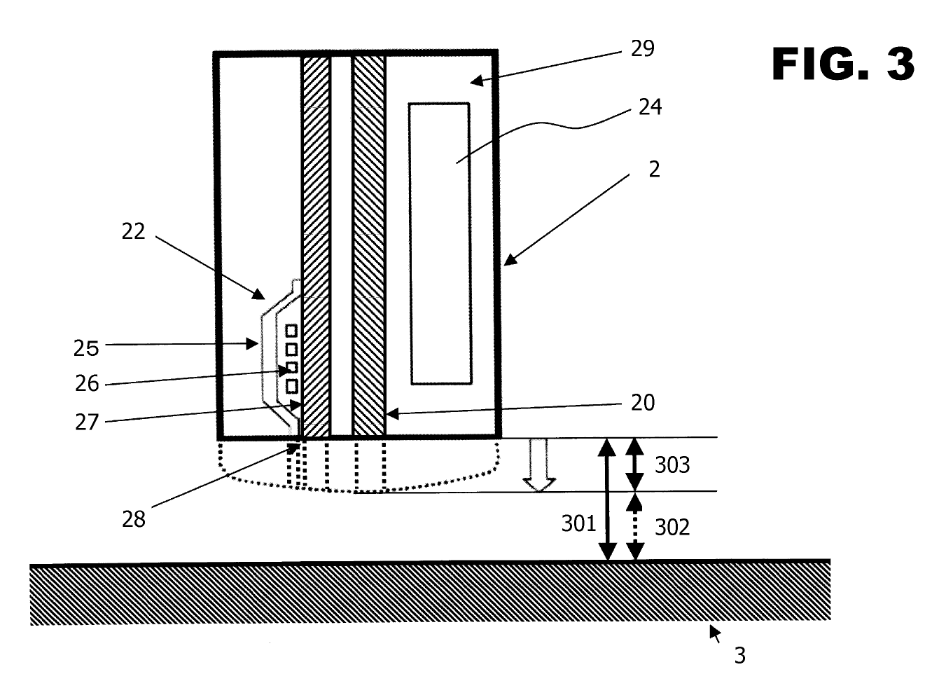

FIG. 1 illustrates a magnetic recording device in accordance with one embodiment of the present invention. FIG. 2 illustrates a read/write channel circuit (RDC), a preamplifier and a magnetic head of FIG. 1. FIG. 3 illustrates in detail the magnetic head of FIGS. 1 and 2. FIG. 1 illustrates a magnetic disk device as the magnetic recording device. As illustrated in FIG. 1, the magnetic disk includes a drive mechanism (disk enclosure) 1, and a printed circuit assembly (PCA) 10. In the disk enclosure (DE) 1, a magnetic disk 3 as a magnetic recording medium is fixed on a rotary shaft of a spindle motor 4. The spindle motor 4 spins the magnetic disk 3. An actuator (also referred to a voice coil motor) 5 includes a magnetic head 2 at the end of an arm and suspension, and moves the magnetic head 2 radially across and over the magnetic disk 3.

The actuator 5 includes a voice coil motor (VCM) spinning about the rotary shaft thereof As illustrated in FIG. 1, the magnetic disk device includes two magnetic disks 3, and four magnetic heads 2 driven by the same actuator 5 at the same time.

As will be described later, the magnetic head 2 includes a read element and a write element. The magnetic head 2 is manufactured by laminating the read element including a magneto-resistive (MR) sensor on a slider and then the write element including a write coil on the read element.

A preamplifier (head IC) 6 to be discussed with reference to FIG. 2 is attached to a side of the actuator 5 of the DE 1. The DE 1 also includes a temperature sensor 7 measuring the temperature inside the DE 1.

The printed circuit assembly (PCA) 10 includes a hard disk controller (HDC) 14, a micro-controller unit (MCU) 13, a read/write channel circuit (RDC) 12, a servo control circuit 17, a data buffer (RAM) 15, and a read-only memory (ROM) 16. In this embodiment, the HDC 14, the MCU 13, and the RDC 12 are integrated in a single LSI 11.

The read/write channel circuit (RDC) 12, connected to the preamplifier 6, controls data reading and data writing on the magnetic disk 3. In other words, the RDC 12 performs data modulation and data demodulation. The servo control circuit (SVC) 17 drives and controls not only the spindle motor 4 but also the actuator 5.

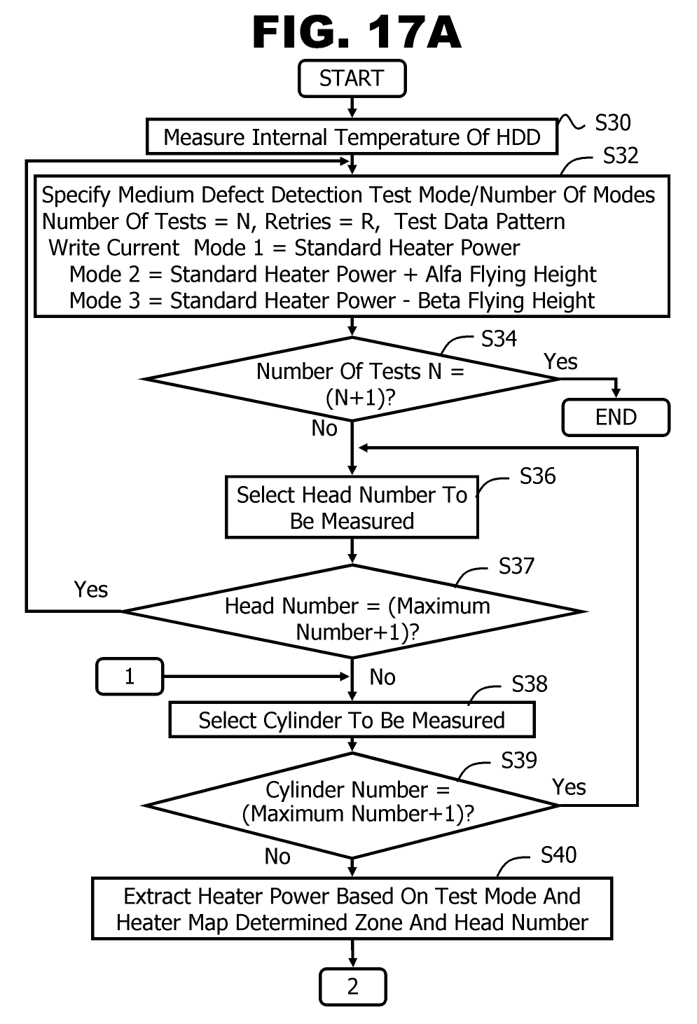

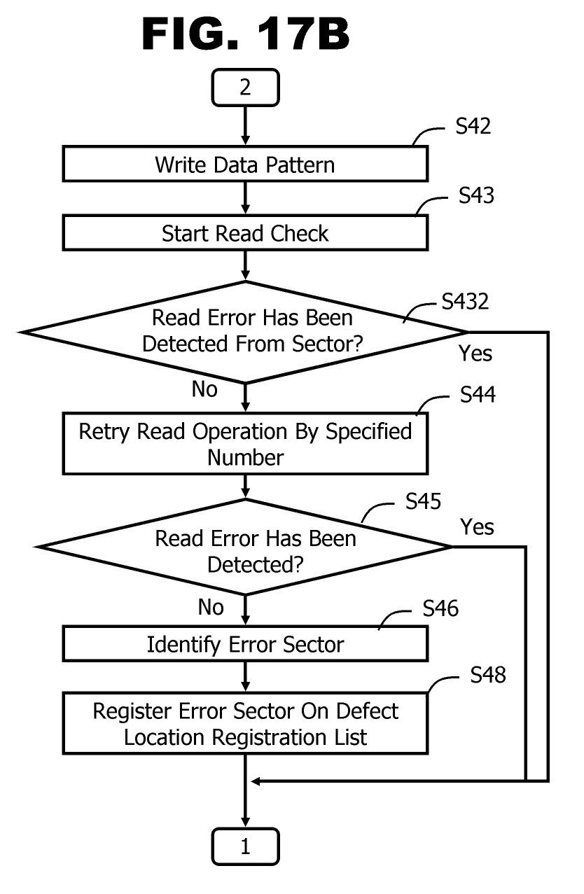

The hard disk controller (HDC) 14 performs mainly interface protocol control, data buffer control, and disk format control. The data buffer (RAM) 15 temporarily stores read data and write data. The data buffer 15 also stores a heater power map 18 to be described with reference to FIGS. 13 and 14, and a defect location registration list 19 to be discussed with reference to FIG. 17A and FIG. 17B. The heater power map 18 and the defect location registration list 19 are stored on a system region of the magnetic disk 3. At the start of the device, the heater power map 18 and the defect location registration list 19 are read from the system region of the magnetic disk 3 and stored onto the data buffer (RAM) 15.

The micro-controller unit (MCU) 13 controls the HDC 14, the RDC 12, and the SVC 17 and manages the RAM 15 and the ROM 16. The ROM 16 stores a variety of programs and parameters.

Referring to FIG. 2, the magnetic head 2 includes a read element 20 (including a magneto-resistive element such as TMR) and a write element (induction element) 22, and a heater 24.

The preamplifier 6 includes a read amplifier 64 for amplifying a read signal from the read element 20 and outputting the amplified signal to the read/write channel circuit 12, a write amplifier 63 for amplifying a write signal from the read/write channel circuit 12 and outputting the amplified signal to the write element 22, a heater driver circuit 61 for receiving a set power amount from the read/write channel circuit 12 and driving the heater 24 of the magnetic head 2, and a heater control circuit 60 for controlling the heater driver circuit 61.

FIG. 3 illustrates in detail the magnetic head 2. The write element 22 is manufactured by winding a coil 26 around an upper magnetic pole 25 and a lower magnetic pole 27. A magnetic field generated in response to a current flowing through the coil 26 appears at a write gap 28, thereby writing data onto the magnetic disk 3.

The read element 20 is arranged in parallel with the lower magnetic pole 27. The heater 24 covered with a head resin 29 is arranged beside the read element 20. An amount of heat generated by the heater 24 is controlled by a heater current that flows therethrough. In response to the amount of heat generated, a thermal expansion is caused in a direction denoted by a blank arrow mark in FIG. 3.

Since the thermal expansion takes place beneath the bottom layer of the head, namely, on surface of the head facing the magnetic disk 3 in a downward direction in FIG. 3, the magnetic head 2 virtually pushes itself toward the magnetic disk 3. This is referred to as a push amount 303.

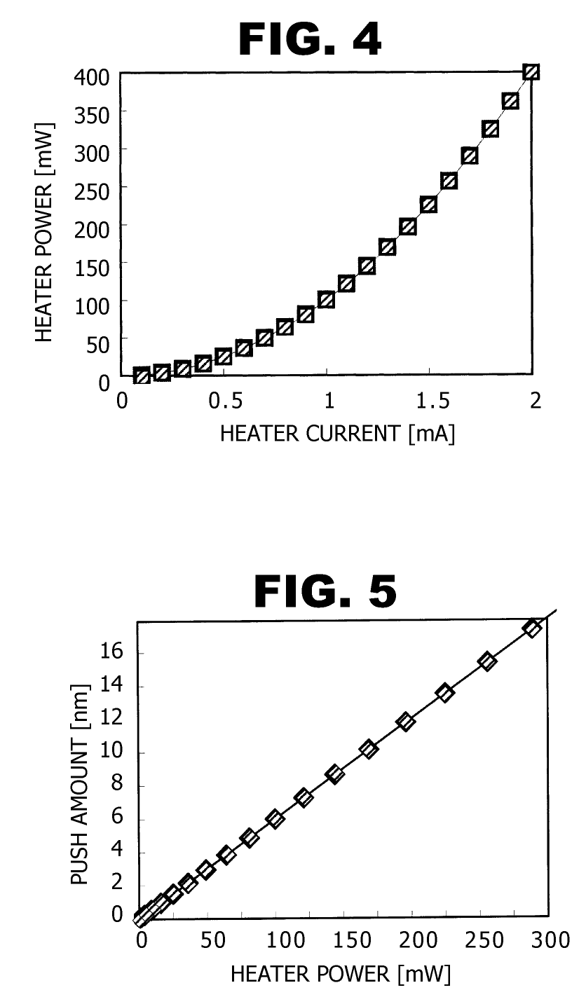

FIG. 4 illustrates a relationship between a heater current and a heater power with the heater 24 having a resistance of 100 ohms. FIG. 5 illustrates a relationship of the push amount 303 of the head responsive to the heater power. As illustrated in FIG. 3, the head flying height is maintained at a value of “301” normally (prior to application of the heater current). With the heater current applied, the thermal expansion takes place in response to the heater power as denoted by broken lines in FIG. 3. The push amount changes depending on the applied heater power as illustrated in FIG. 5. The head flying height increases in response to the push amount, thereby reaching a value of “302” as illustrated in FIG. 3.

Using such a magnetic head, a heater power map is produced in order to perform the head flying height control as described below.

Production of Heater Power Map

The flying height changes depending on the magnetic head and the position of the magnetic head. To keep the flying height constant, the heater power needs to be changed depending on the magnetic head and the position of the magnetic head. The heater power to keep the flying height constant in response to the magnetic head and the position of the magnetic head is measured, and then the heater power map is produced. The necessity of controlling the magnetic head to a constant flying height position is described below.

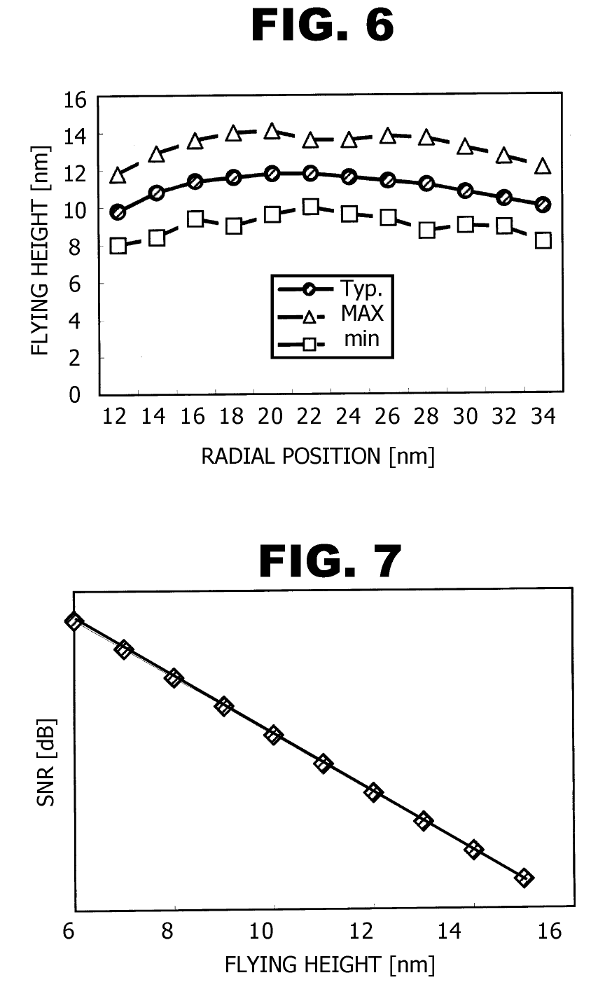

FIG. 6 illustrates a relationship of the flying height of the magnetic head with respect to the position of the magnetic head radially across and with respect to the magnetic disk medium. In FIG. 6, the abscissa represents the radial position (mm) and the ordinate represents the flying height (μm). The flying height of the magnetic head is not uniform nor constant radially across the magnetic disk medium. Windage loss of the magnetic head caused by the flying posture and wind disturbance changes negative pressure, and the flying height varies as represented by symbol Typ (denoted by solid circles) with respect to the radial position. The flying height characteristics also change from head to head as represented by MAX (denoted by triangles) and min (denoted by squares).

FIG. 7 illustrates a signal to noise ratio (SNR) of a signal read from the read element (MR sensor) with the flying height changing. In FIG. 7, the abscissa represents the flying height (nm) and the ordinate represents the SNR (dB).

As illustrated in FIG. 7, the larger the flying height, the smaller the SNR becomes, and the smaller the flying height, the larger (better) the SNR becomes.

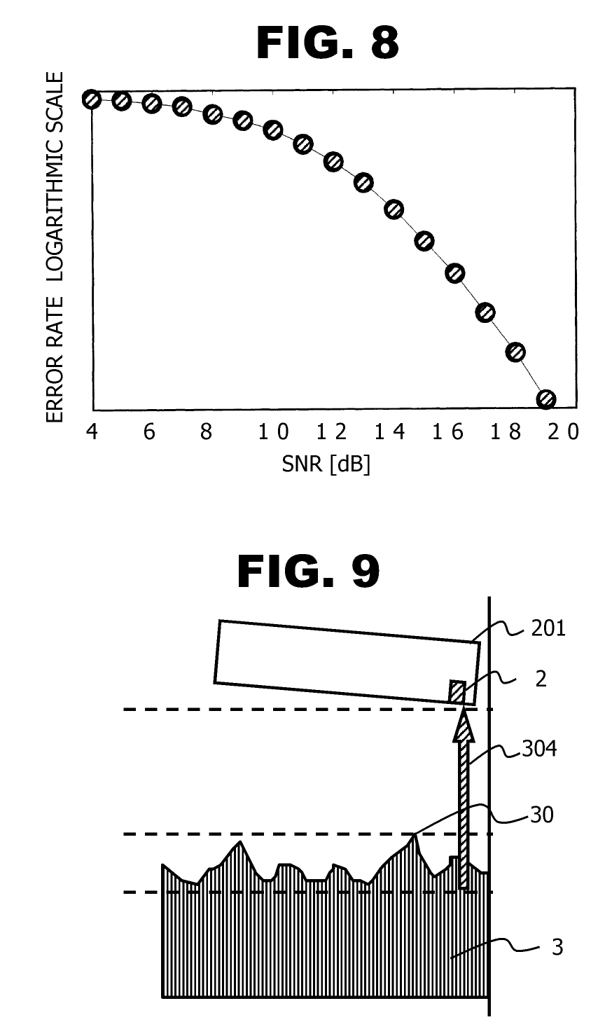

FIG. 8 illustrates a relationship between the SNR of the signal read from the read element and an error rate of the read data. In FIG. 8, the abscissa represents the SNR (dB), and the ordinates represents the error rate (logarithmic scale). As illustrated in FIG. 8, the better the SNR, i.e., with the flying height reduced, the smaller the error rate becomes. The probability of data error drops and signal quality is thus improved. Conversely, a larger flying height reduces the SNR, leading to a higher error rate. The probability of data error increases and signal quality may drop.

The flying height of the magnetic head is in proportional to the SNR of the signal read from the magnetic head. More specifically, if the flying height is small, the SNR increases, leading to a high read signal quality. As a result, reading margin is increased, and the read error rate is improved.

With the flying height being large, the SNR decreases, leading to a low read signal quality. If the flying height of the magnetic head is adjusted and optimized in response to the individual head and the position of the head radially across the disk medium, the read error rate is improved.

FIG. 9 diagrammatically illustrates a flying state of a slider including a magnetic head with respect to the magnetic disk medium. The magnetic disk 3 has ideally a flat surface, but has a surface roughness in microscopic view as illustrated in FIG. 9. The surface roughness depends on texture technique, polishing technique, etc. The surface roughness illustrated in FIG. 9 includes many projections 30.

The magnetic head 2 is mounted on a slider 201, and floats with a predetermined flying height from the magnetic disk 3 when the magnetic disk 3 spins. If the head flying height 304 is reduced in FIG. 9, or if a projection 30 larger than those illustrated in FIG. 9 is present, the magnetic head 2 hits the projection 30, possibly leading to a thermal asperity phenomenon.

If the thermal asperity phenomenon repeatedly occurs, impact traces damage the head, and become a cause of characteristic degradation of the head. If the flying height is further reduced, an air bearing surface (ABS) of the head touches the magnetic disk 3. A lubricant applied on the surface of the disk medium may stick to the ABS surface. Contact scratches may be created on the ABS surface. Such irregularities adversely affect the flying height and the flying posture of the head, posing a risk of head crash.

Adjusting and optimizing the head flying height in response to the individual head and in response to the position of the head radially across the disk medium are effective to control variations particularly when the head is flying at a small height, and are also effective to prevent head crash that is caused by a head-disk interface.

In order to adjust and optimize the head flying height in response to the individual head and in response to the position of the head radially across the disk medium, the heater of the head is used to cause the thermal expansion in the amount of push. The push amount is responsive to the heater power. The heater power keeping the head flying height constant is determined to produce the heater power map.

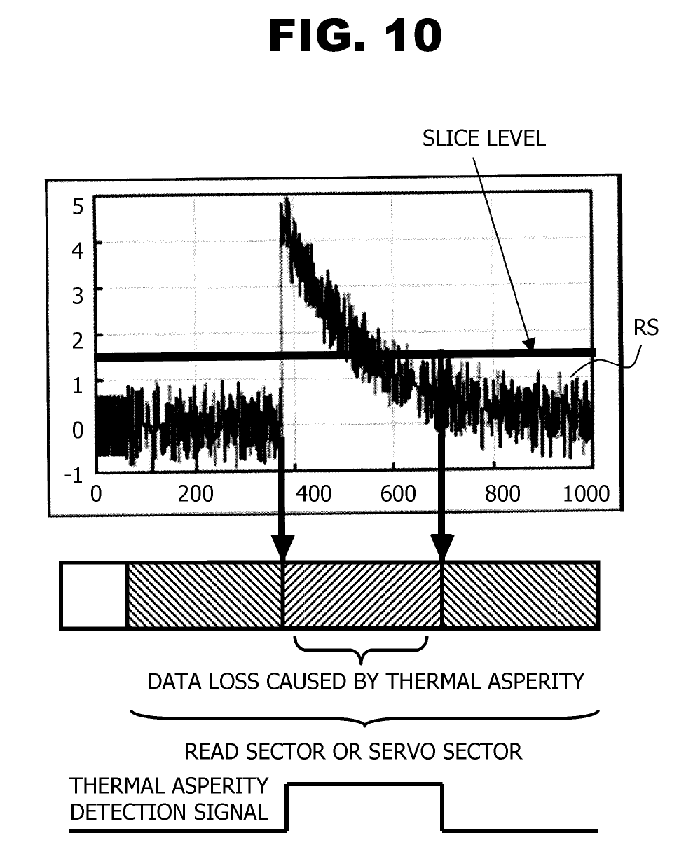

FIG. 10 illustrates the thermal asperity. Thermal energy generated when the magnetic head 2 impacts the projection 30 changes thermal response, thereby changing a resistance of the read element 20 of the magnetic head 2. The thermal response generates a direct-current voltage offset as represented by a read signal RS of the read element 20, and gradually attenuates in response characteristics.

The thermal asperity, if occurring with the read signal corresponding to a data sector as illustrated in FIG. 10, causes a data loss. The data loss is detected as a read error. A slice level SL is set in the read signal RS of FIG. 10, and a thermal asperity (TA) detection signal is generated according to the slice level SL. The thermal asperity is thus detected.

In order to determine a heater power for appropriate flying height, the above-described thermal asperity may be positively used. The heater 24 pushes the magnetic head 2, thereby reducing the flying height. A location where the thermal asperity (TA) is detected is recognized as a zero flying height point. The flying height is calculated from the relationship between the heater power and the amount of push illustrated in FIG. 5, and a target flying height is thus set.

The magnetic head operates with a reliable flying height property. Even when the flying height is small, and varied from head to head, the head crash caused by the head touching the magnetic disk medium is prevented. The reliable flying height property also controls degradation in the head output characteristics caused by the lubricant of the magnetic disk sticking to the head.

Even when variations in the head flying height from head to head are relatively large, an increase in the read error rate is avoided. The increase in the read error rate is typically caused by a drop in write performance resulting from extension of the coverage of a write head magnetic field and by a drop in the SNR of the read signal.

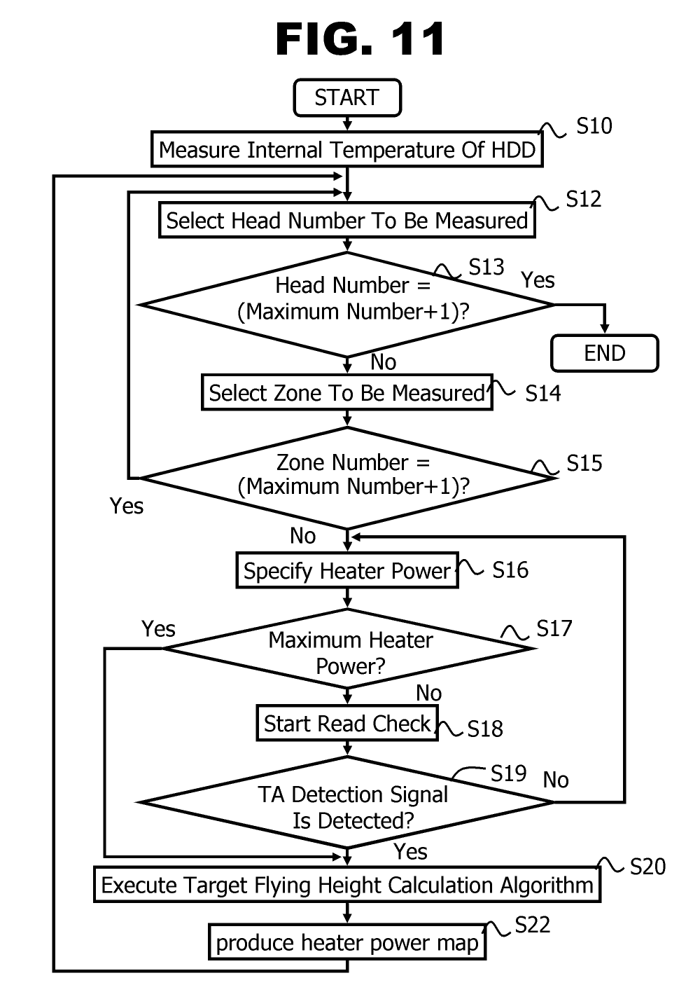

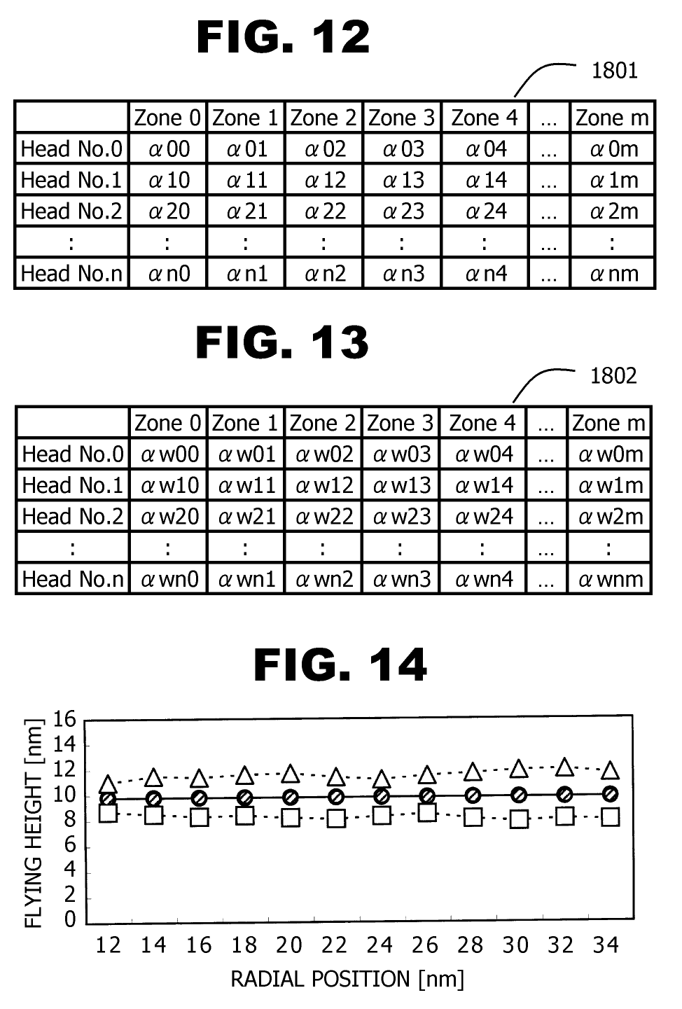

FIG. 11 is a flowchart of a heater power map production process in accordance with one embodiment of the present invention. FIGS. 12 and 13 illustrate the heater power maps produced through the process of FIG. 11.

The process of FIG. 11 is performed when the MCU 13 of FIG. 1 executes a measurement program stored on one of the RAM 15 and the ROM 16. In the process of FIG. 11, the measurement process is performed for each head of the HDD, and the heater power to be set to control the flying height on each zone that is formatted in accordance with zone bit recording (ZBR) is measured on each ambient temperature at which the HDD is used (on each internal temperature of the HDD).

The MCU 13 measures the internal temperature of the DE (HDD) 1 with the temperature sensor 7 in step S10. For example, at a test phase prior to shipping, the temperature measurement is performed at a high-temperature point, a medium-temperature point and a low-temperature point. Alternatively, the temperature measurement may be performed in steps of 5° C. in a range of from 0° C. to 60° C.

The MCU 13 specifies and selects a head number to be measured in the order from small to large number in step S12. The MCU 13 determines whether the specified head number reaches (a maximum number+1). If it is determined that the specified head number is (the maximum number+1), the MCU 13 ends the measurement process because all the heads have already been measured.

If it is determined in step S13 that the specified head number is not (the maximum number+1), the MCU 13 specifies and selects a zone to be measured in the order from small to large number in step S14. A plurality of zones are set up radially across the magnetic disk and the measurement is performed on a per zone basis. The MCU 13 determines whether the measurement zone number specified is (the maximum number+1). If it is determined in step S15 that the measurement zone number specified is (the maximum number+1), the MCU 13 returns to step S12 because all the zones for that head have been measured.

If it is determined in step S15 that the measurement zone number specified is not (the maximum number+1), the MCU 13 specifies a power of the heater 24 of the magnetic head 2 in step S16. The power is successively updated in the order of from a small value to a large value. The MCU 13 determines whether the specified heater power is the maximum heater power in step S17. If it is determined in step S17 that the specified heater power has reached the maximum heater power, the MCU 13 proceeds to step S20.

If it is determined in step S17 that the specified heater power has not reached the maximum heater power yet, the MCU 13 starts a read check in step S18. More specifically, the MCU 13 sets the specified heater power at the heater control circuit 60, drives the heater 24 at the specified heater power, and writes test data onto the magnetic disk 3 with the write element 22 of the magnetic head 2. The MCU 13 then reads the written test data with the read element 20 of the magnetic head 2, and performs the read check in step S19. In the read check, the MCU 13 determines whether a TA detection circuit (not illustrated) in the RDC 12 has generated a TA detection signal discussed with reference to FIG. 10. In the read check, the MCU 13 determines whether a read error has been detected. If it is determined in step S19 that no TA detection signal has been detected, or if it is determined in step S19 that no read error has been detected, the MCU 13 returns to step S16. The MCU 13 specifies a higher power (equal to the amount of push).

If it is determined in step S19 that the TA detection signal has been detected or if it is determined in step S19 that the read error has been detected, the MCU 13 executes a target flying height calculation algorithm to be discussed later in order to calculate the heater power corresponding to the target flying height in step S20.

The MCU 13 produces the heater power map to be discussed with reference to FIGS. 12 and 13, and then ends the head measurement process. The MCU 13 returns to step S12 to measure the next head in step S22.

The target flying height calculation algorithm of FIG. 11 is described below. As discussed with reference to FIG. 5, a heater power α and a head push amount β are related by the following approximation equation (1):

β=0.06α−2⁻¹⁵ (1)

If it is determined in step S19 that either the TA detection signal or the read error has been detected at the heater power α, the lowest surface of the head has a flying height of zero. Let γ represent a target flying height and, a difference between the head push amount β and the heater power α is determined from equation (1) as represented by the following equation (2):

α=[(β−γ)+2⁻¹⁵]/0.06 (2)

The heater power α to be set to obtain the target flying height is calculated using equation (2).

In practice, a heater current to be set is determined from the heater power in accordance with the relationship of FIG. 4. For example, the head push amount β is 12 nm at the heater power α=200 mW. With the head flying height of zero at the lowest level at this heater power, the head flying height γ may be set to be 10 nm. The heater power to be set is 33 mw from equation (2). The magnetic head can be used with a head push amount β of 2 nm and a predetermined flying height at a heater power of 33 mW.

The heater power map is described below with reference to FIGS. 12 and 13. FIG. 12 illustrates a heater power map 1801 listing heater power set values when a read operation is requested. FIG. 13 illustrates a heater power map 1802 when a write operation is requested.

The heater power map 1801 stores heater powers α00-αnm in response to the head numbers 0-n and the zone numbers 0-m. The heater power map 1801 of FIG. 12 is produced for each of the temperatures measured at step S10. The heater power map 1802 stores heater powers αw00-αwnm in response to the head numbers 0-n and the zone numbers 0-m. The heater power map 1802 of FIG. 13 is produced for each of the temperatures measured at step S10.

The heater power map may be stored in a predetermined area of the magnetic disk 3 or a non-volatile memory such as the ROM 16.

When the write operation is requested, heat is additionally is caused by the flowing of a write current. A heater power that is corrected by subtracting the heat amount caused by the write current from the heater power set at the read request is preferably used. The corrected heater power is thus stored in the map as illustrated in FIG. 13.

The measurement is preferably performed at the test phase prior to product shipping. An automatic calibration may be performed after product shipping. The measurement may be performed on one zone only, for example, on a zone number 0 rather than on all the zones, and then the measurement results may be applied to the remaining zones. Preferably, the measurement values of the remaining zones are calculated from a flying profile (characteristics) with reference to the radial position of FIG. 6.

The measurement may be performed in any area of the magnetic disk. Preferably, the measurement is performed on a system region not a user region of the magnetic disk because the magnetic head is placed into contact with the magnetic disk.

When an access request to the head and the zone is input, the MCU 13 sets the heater power value corresponding to the maps 1801 and 1802 using the maps 1801 and 1802, and controls the magnetic head to the target flying height. At each internal temperature setting in the HDD, the target flying height is set. More specifically, the internal temperature of the HDD is measured at the access request, and the map value matching the temperature is used.

Defect Detection Process

At the product shipping test of the magnetic disk device, a medium defect detection error test is performed. As previously discussed, the flying height can vary even after the flying height of the head with respect to the medium is controlled to a constant value.

FIG. 14 illustrates such variations in the head flying height. The abscissa represents the radial position (mm), and the ordinate represents the head flying height (nm). The flying height is controlled to a constant value radially across the magnetic recording disk as denoted by solid circles in FIG. 14. Even after such control process has been performed, the flying height actually varies in a vertical direction with respect to the magnetic disk as denoted by blank triangles or blank squares in FIG. 14 if the flying height at a predetermined rotational speed of the magnetic disk is statistically measured.

Even after the control process of controlling the flying height to a constant value is completed, there is still a possibility that the medium projection or the thermal asperity phenomenon, discussed with reference to FIGS. 9 and 10, takes place in the actual use of the magnetic disk device.

During the medium defect detection error test performed after the flying height is determined with the algorithm for the constant flying height control completed, the defect detection test is performed taking into the above-described variations in the flying height.

More specifically, the defect detection test is performed with the flying height reduced. If the flying height is controlled to 10 nm, the defect detection test is performed with the flying height reduced to 9 nm taking into consideration the variations in the flying height. In this way, the spacing margin to the medium projection is increased to easily detect the medium projection, and a potential group of thermal asperity is detected preliminarily.

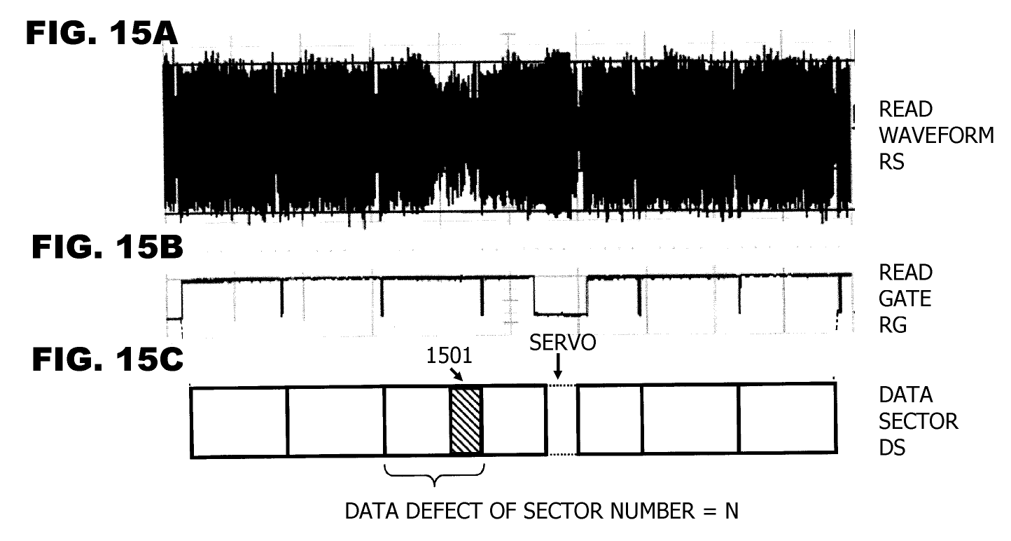

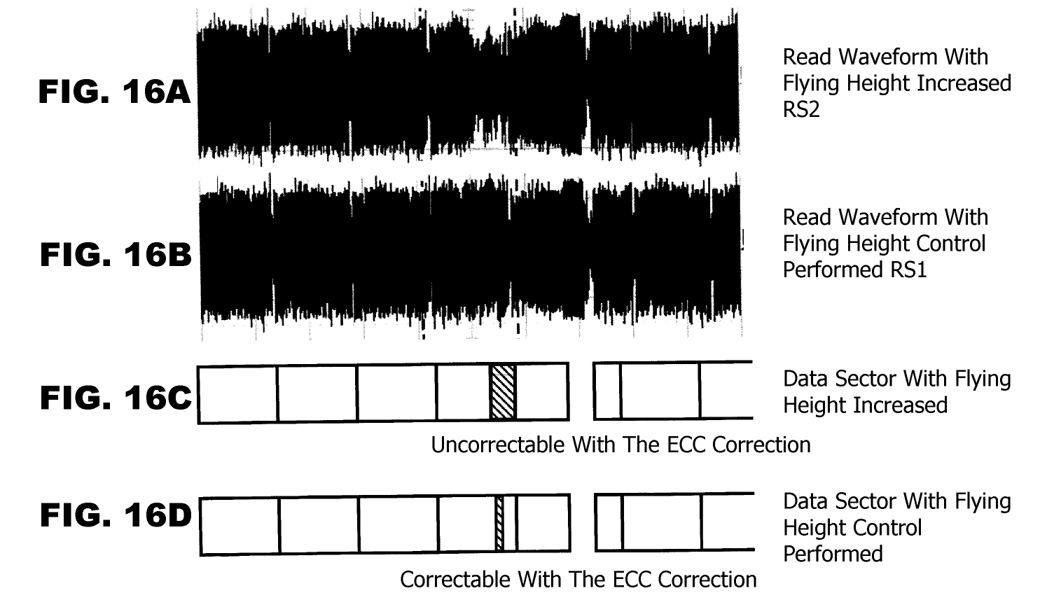

The medium defect is described below. FIG. 15A, FIG. 15B, and FIG. 15C illustrate a read waveform caused by a medium defect. FIG. 16A, FIG. 16B, FIG. 16C, and FIG. 16D illustrate a read waveform obtained when the flying height is changed. FIG. 15A, FIG. 15B, and FIG. 15C illustrate an error sector at a medium defect location detected in an error test normally performed. As illustrated in FIG. 15A, FIG. 15B, and FIG. 15C, a defect location (area 1501 of the data sector) of the medium defect, namely, insufficient coupling of particles forming the magnetic layer appears in a drop of the level of the read waveform. The drop of the level of the read waveform makes a normal signal reproduction difficult, and results in a read error.

In the medium defect error test, an error correction is generally performed on a permissible error bit with the correction level of error correction code (ECC) set to be lower than that for a standard operation mode.

A lower waveform RS1 of FIG. 16B is a read waveform with the flying height control performed. A small level variation is noticed, but an error bit length is short, and correctable through the ECC correction. Such a level variation is not detected through an error test.

An upper waveform RS2 of FIG. 16A is obtained by writing data with the head flying height increased and then reading the written data. The increased flying height lowers write performance level, and degrades the SNR as electromagnetic conversion characteristics. A read waveform level drop, which is not observed in the reduced flying height, appears.

The upper waveform of FIG. 6 is at a level incorrectable with the ECC correction performance set in the error test. When the medium defect appears as a result of the increased head flying height, the error test is performed with a slight increase introduced in the flying height set at the flying height control process. The medium defect is registered as a potential medium defect group in the medium defect list. More specifically, the medium defect is re-assigned as a sector not used in a normal operation.

In the flying height control process, the detection margin is reduced with respect to the medium defect because of the small spacing of the head above the magnetic recording medium. More specifically, an increase in the impact probability to the medium defect is likely to be a cause of the read error. The medium defect is easy to read since the SNR is increased by the reduced flying height. The read operation with the ECC operative lowers the error generation probability, and the defect portion is likely to escape detection.

During the defect detection, a defect location is easily detected by varying the head flying height, and the detected location is then registered in a defect list. By not using the defect location, the data error generation probability is reduced.

FIG. 17A and FIG. 17B are flowcharts illustrating the defect detection process. The defect detection process is performed after the flying height is determined through the algorithm for the constant flying height control of one embodiment of the present invention completed. The defect detection process of FIG. 17A and FIG. 17B is one of medium tests to be performed after the flying height is determined through the algorithm for the constant flying height control. The MCU 13 executes the defect detection process.

The MCU 13 measures the internal temperature of the DE (HDD) 1 with the temperature sensor 7 in step S30. For example, at a test phase prior to product shipping, the temperature measurement is performed at a high-temperature point, a medium-temperature point and a low-temperature point. Alternatively, the temperature measurement may be performed only at a high-temperature point.

The MCU 13 specifies a medium defect detection test mode and the number of modes in step S32. The test modes that can be specified include mode 1 using a standard heater power, mode 2 using (standard heater power+α flying height), and mode 3 using (standard heater power−β flying height). Here, the values of α and β are heater power values converted beforehand from the flying heights. One of the test modes is thus specified. The number of tests n and the number of retries r are also specified. A test pattern and a write current are also specified.

The MCU 13 determines whether the number of tests n is (n+1) in step S34. If it is determined that the number of tests n is (n+1), the specified number of tests has been completed. The medium test is now completed.

If it is determined that the number of tests n is not (n+1), the MCU 13 specifies and selects the head number to be measured in the order of from small to large in step S36. The MCU 13 determines whether the specified head number is (a maximum number+1). If it is determined that the specified head number is (the maximum number+1) in step S37, all the heads have been measured. The MCU 13 returns to step S32 to perform the measurement process at the next mode.

If it is determined that the specified head number is not (maximum number+1) in step S37, the MCU 13 specifies and selects a cylinder to be measured in the order of from small to large number in step S38. The cylinder number corresponds to a track number. If it is determined that the specified cylinder number is (the maximum number+1) in step S39, all the cylinders for that head have been measured. The MCU 13 then returns to step S36.

If it is determined that the specified cylinder number is not (the maximum number+1) in step S39, the MCU 13 extracts the heater power value responsive to the specified head number and the specified cylinder number from the heater power map 1801 of FIG. 12 in step S40. In accordance with the test mode set in step S32, the MCU 13 calculates the heater power value, and sets the calculated heater power value on the heater control circuit 60 (see FIG. 2). If the test mode 1 is set, the MCU 13 sets the heater power value extracted from the heater power map 1801 as it is. If the test mode 2 is set, the MCU 13 sets a value resulting from adding α to the heater power value extracted from the heater power map 1801. If the test mode 3 is set, the MCU 13 sets a value resulting from subtracting β from the heater power value extracted from the heater power map 1801.

The MCU 13 starts the read check. More specifically, the MCU 13 drives the heater 24 at the heater power specified in step S40 with the heater control circuit 60. The MCU 13 writes the data pattern in step S42 set in step S32 on all the sectors at the specified cylinder of the magnetic disk 3 with the measured and specified write element 22 of the magnetic head 2. The MCU 13 reads the data pattern in step S43 written on all the sectors at the specified cylinder of the magnetic disk 3 with the read element 20 of the magnetic head 2. The MCU 13 performs then the read check. The MCU 13 determines in the read check whether any sector has a read error in step S432. If the MCU 13 determines that no read error is detected from the cylinder, processing returns to step S38 to measure the next cylinder.

If it is determined that a read error has been detected from the cylinder, the MCU 13 retries the read operation by the specified number of times to that cylinder in step S44. The MCU 13 thus determines whether any read error has occurred. If it is determined that no read error has been detected in step S45, the MCU 13 returns to step S38 to measure the next cylinder.

Upon detecting the read error, the MCU 13 identifies the error sector in step S46.

The MCU 13 registers the position of the error sector (sector number) on the defect location registration list 19 (see FIG. 1) and sets a substitute sector in step S48. The MCU 13 returns to step S38 to measure the next cylinder.

The number of tests is set depending on the combination of the above-described parameters and the setting of vertical variations of the flying height. The defect detection error test is executed at the target head and cylinder.

Most preferably, one of the test modes 1, 2 and 3 is set. In order to shorten the test time, test modes 1 and 2 or test modes 1 and 3 may be combined.

If the flying height of the head is controlled to a constant value in accordance with a head push amount in this way, a small space head flying becomes possible and signal quality is expected to improve. As for the medium defect, the detection margin is reduced by the small space head flying. The impact probability increases, becoming a cause for the read error. The small space head flying increases the SNR, thereby allowing the medium defect to be easily read. The read operation with the ECC enabled decreases the error generation probability, thereby causing the defect location to be likely to escape detection.

The head flying height is set to be variable during the defect detection so that the defect location is easily detected, and the detected defect location is registered in the defect list. The defect location is set not to be used as a data region, which is typically subject to defect. The data error generation probability is thus reduced.

Since the defect detection process is performed with the heater power modified, the defect detection is possible in the same operation state as the normal operation. A potentially defective sector is thus detected more accurately. Since the defect detection is performed with the flying height increased, not only a defect caused by a roughness of the medium but also a defective sector due to a medium defect is detected.

Read/Write Process of the Magnetic Recording Device

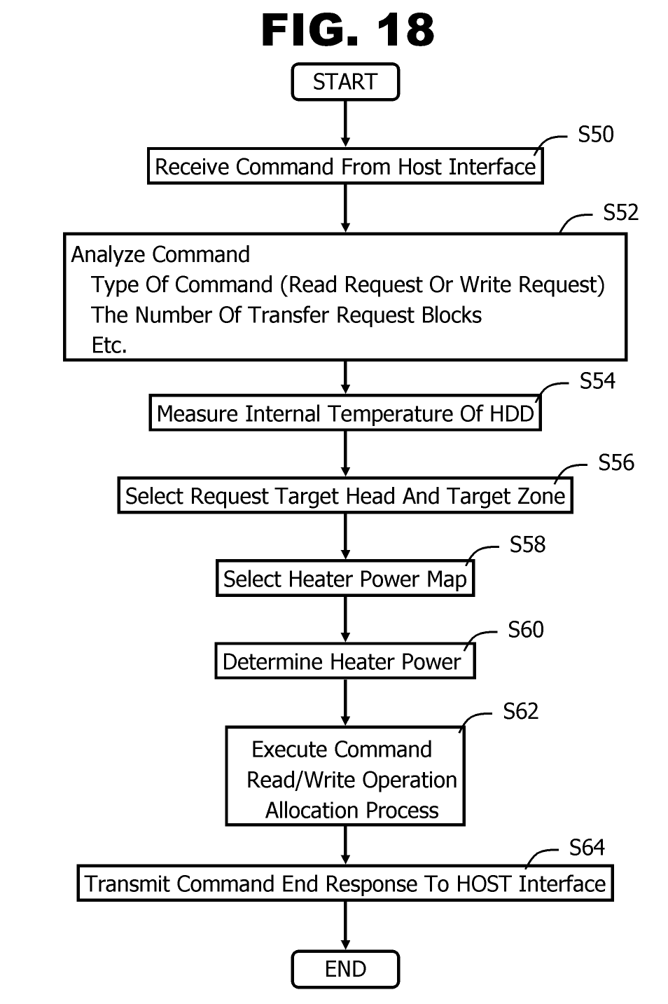

FIG. 18 is a flowchart illustrating of a read/write process in accordance with one embodiment of the present invention.

The hard disk controller (HDC) 14 receives a command from a host apparatus in step S50.

The MCU 13 analyzes the command (command block) from the host apparatus, thereby determining whether the command is a read request or a write request in step S52. The MCU 13 also checks the number of transfer request blocks.

The MCU 13 measures the internal temperature of the HDD with the temperature sensor 7 in step S54.

In step S56, the MCU 13 selects a request target head and a target zone containing requested data in response to the analysis results in step S52.

The MCU 13 reads data from the system region of the magnetic disk 3, and selects the heater power map 18 expanded on the RAM 15 in accordance with the measured temperature, and the read/write request in step S58.

The MCU 13 searches the selected heater power map 18 in accordance with the requested head and target zone, determines the corresponding heater power value, and then sets the determined heater power on the heater control circuit 60 in step S60.

The MCU 13 executes the command together with the HDC 14 in step S62. More specifically, the MCU 13 references the defect location registration list 19, and determines whether the target sector is registered in the defect location registration list 19. If the target sector is registered in the defect location registration list 19, the MCU 13 determines a substitute sector position. The MCU 13 controls the target head to the target flying height at the heater power while performing the data read/write operation on one of the target sector and the substitute sector.

After the read/write operation, the MCU 13 transmits a command end response via the HDC 14 in step S64.

Since the potentially defective sector is registered beforehand, the error generation probability is lowered even if variations occur. The generation probability of the read/write error due to the variations in the head flying height is lowered. The request from the host apparatus is thus executed reliably at a high speed.

Subsequent to the reception of the request from the host apparatus, the possibility that a sector allocation process is reduced, and response speed to the host apparatus is increased.

Other Embodiments

In the above-described embodiments, the magnetic disk device includes two magnetic disks. The present invention is applicable to a magnetic disk device having one disk or three or more disks. The present invention is not limited to the magnetic head of FIG. 2. For example, the present invention is applicable to a separate-type magnetic head.

The heater driver circuit may be mounted not on the head IC but on the controller. The magnetic head may include the read element and the heater element. When the medium defect detection is performed with the flying height increased, the write current may be reduced below the standard value thereof in order to lower the write performance. In this way, the medium defect resulting from the insufficient coupling of particles on the magnetic layer of the disk medium is accurately detected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A data recording device for storing data, comprising:
a medium for storing data;
a head assembly including a read element for reading out data stored in the medium and a heater for controlling a distance between the read element and the medium within a predetermined range during data reading out by the read element; and
a processor for executing a test process comprising:
controlling the distance between the read element and the medium in a test range outside the predetermined range by controlling the heater, and
reading out test data from the medium while the distance between the read element and the medium is maintained in the test range so as to evaluate the data recording device.

2. The data recording device according to claim 1, further comprising determining defect area of the medium on the basis of the data read out by the read element.

3. The data recording device according to claim 2, further comprising a memory for storing information of the detected defect area of the medium, wherein the test process further comprises setting a substitute area for the defect area.

4. The data recording device according to claim 1, wherein the test process further comprises calculating a control value for resulting in a flying height larger than the set flying height on the basis of the control value for reading data, and detecting the defect area on the medium while controlling the read element to a flying height larger than the set flying height by driving the heater with the calculated control value.

5. The data recording device according to claim 1, wherein the test process further comprises calculating a control value for resulting in a flying height smaller than the set flying height on the basis of the control value for reading data, and detecting the defect area on the medium while controlling the read element to a flying height smaller than the set flying height by driving the heater with the calculated control value.

6. The data recording device according to claim 2, further comprising write element for writing data into the medium, wherein the test process further comprises writing on the medium predetermined data with the write element, and reading data from the medium with the read element in order to detect the defect, wherein a write current of the write element in defect detection is set to be smaller than a write current in a normal data write operation.

7. The data recording device according to claim 1, further comprising write element for writing data into the medium, wherein the test process further comprises writing on the medium predetermined data with the write element, and reading data from the medium with the read element in order to detect the defect.

8. The data recording device according to claim 1, wherein the test process further comprising determining from a data read by the read element whether the read element has touched the medium while increasing the control value to the heater and calculating the set control value corresponding to the set flying height from the control value at which the read element has touched the medium.

9. The data recording device according to claim 1, further comprising a memory having a table for storing control value of the heater, the table having the set control value on each of zones into which the medium is radially partitioned, wherein the test process further comprising controlling the flying height of the read element with respect to the medium to the set flying height by driving the heater with a control value in the table corresponding to a position of the read element radially across and with respect to the medium.

10. The data recording device according to claim 1, further comprising a memory having a table for storing control value of the heater, the table having the set control value on each of zones into which the medium is radially partitioned, wherein the test process further comprising controlling the flying height of the read element with respect to the medium to the set flying height by driving the heater with a control value in the table corresponding to a selected read element and a position of the read element radially across and with respect to the medium.

11. The disk device according to claim 7, wherein the test process further comprises detecting one of a thermal asperity and a read error from a read data from the read element in order to determine whether the read element has touched the medium.

12. A method for controlling a data recording device for storing data including a medium for storing data, and a head assembly including a read element for reading out data stored in the medium and a heater for controlling a distance between the read element and the medium within a predetermined range during data reading out by the read element, the method comprising:
controlling the distance between the read element and the medium in a test range outside the predetermined range by controlling the heater, and
reading out test data from the medium while the distance between the read element and the medium is maintained in the test range so as to evaluate the data recording device.
